(19) United States
(12) Patent Application Publication
(10) Pub. No.: US 2007/0201460 A1
(43) Pub. Date: Aug. 30, 2007

(54) Data transmitting and receiving apparatus, data transmitting and receiving method, and computer product

(75) Inventors: Shuei Hatamori, Kawasaki (JP); Masaaki Nagatsuka, Kawasaki (JP); Takuji Takahashi, Kawasaki (JP); Hiroyuki Oka, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/443,090

(22) Filed: May 31, 2006

(30) Foreign Application Priority Data
Feb. 27, 2006 (JP) 2006-050701

(51) Int. Cl. H04L 12/56; H04L 12/28

(52) U.S. Cl. 370/389; 370/412

(57) ABSTRACT

In a data transmitting and receiving apparatus, payloads of packets received from the first device are accumulated in a storage unit, a designated payload volume DSPS is calculated based on DSPS=TP×(1−RR/TR), where TP is a total payload volume of a packet received at a certain time point from the first device, RR is receiving rate of packets, and TR is transmitting rate of packets, and transmission is-started of the payload accumulated in the storage unit to the second device when a payload volume RPS accumulated in the storage unit has reached the designated payload volume DSPS.

### BACKGROUND OF THE INVENTION

1. Field of the Invention

The present invention generally relates to a technology for transmitting packets received from one external device to another external device.

2. Description of the Related Art

One of the conventional packet transmitting and receiving methods used over networks is what is known as a cut-through method which allows received packets to be transmitted quickly. Such a technology is disclosed, for example, in Japanese Patent Laid-Open Publication No. 2001-257680. Precisely, a network device, which employs the cut-through method based on a direct memory access (DMA), allows other network devices to have a direct memory access (DMA) to packets received by the network device even before it receives all the packets of certain data.

However, in the conventional technology, there is a threat of buffer underruns, i.e., packets in the incoming data buffer are exhausted. In other words, if DMA starts before all the packets are accumulated in an incoming data buffer of the network device, and if a receiving rate of the packets is slower than a transmitting rate, at some time point the incoming data buffer becomes empty of packets. Such buffer underrun leads to various serious issues, for example, data garbling due to attempted transmission of non-existent data, etc. Buffer underruns can similarly occur in network devices employing the cut-through method.

Thus, there is a need of a technology that prevents occurrence of underruns on a network device that employs the cut-through method.

### SUMMARY OF THE INVENTION

It is an object of the present invention to at least partially solve the problems in the conventional technology.

According to an aspect of the present invention, a data transmitting and receiving apparatus that accumulates packets received from a first device and transmits accumulated packets to a second device without waiting for receiving all packets belonging to certain data from the first device, includes a storage unit that accumulates therein payloads of packets received from the first device; a payload-volume calculating unit that calculates a designated payload volume DSPS based on DSPS=TP×(1−RR/TR) where TP is a total payload volume of a packet received at a certain time point from the first device, RR is receiving rate of packets, and TR is transmitting rate of packets; a payload-volume determining unit that determines whether payload volume RPS accumulated in the storage unit has reached the designated payload volume DSPS; and a payload transmission control unit that, if the payload volume determining unit determines that the payload volume RPS has reached the designated payload volume DSPS, provides a control to start transmission of the payload accumulated in the storage unit to the second device.

According to another aspect of the present invention, a data transmitting and receiving method of accumulating packets received from a first device and transmitting accumulated packets to a second device without waiting for receiving all packets belonging to certain data from the first device, includes accumulating payloads of packets received from the first device in a storage unit; calculating a designated payload volume DSPS based on DSPS=TP×(1−RR/TR) where TP is a total payload volume of a packet received at a certain time point from the first device, RR is receiving rate of packets, and TR is transmitting rate of packets; determining whether payload volume RPS accumulated in the storage unit has reached the designated payload volume DSPS; and starting transmission of the payload accumulated in the storage unit to the second device when it is determined at the determining that the payload volume RPS has reached the designated payload volume DSPS.

According to still another aspect of the present invention, a computer-readable recording medium stores therein a computer program that implements the above method on a computer.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is schematic for explaining an overview of a data transmitting and receiving apparatus according to an embodiment of the present invention;

FIG. 2 is functional block diagram of a data transmitting and receiving apparatus according to a first concrete example of the embodiment;

FIG. 3 is drawing for explaining calculation of a DMA-initiation payload volume according to the first concrete example; and

FIG. 4 is flowchart of a process procedure performed by the data transmitting and receiving apparatus shown in FIG. 2.

### DETAILED DESCRIPTION OF THE PREFERRED EMBODIMENTS

Exemplary embodiments of the present invention are explained below with reference to the accompanying drawings. The present invention is not limited by those embodiments.

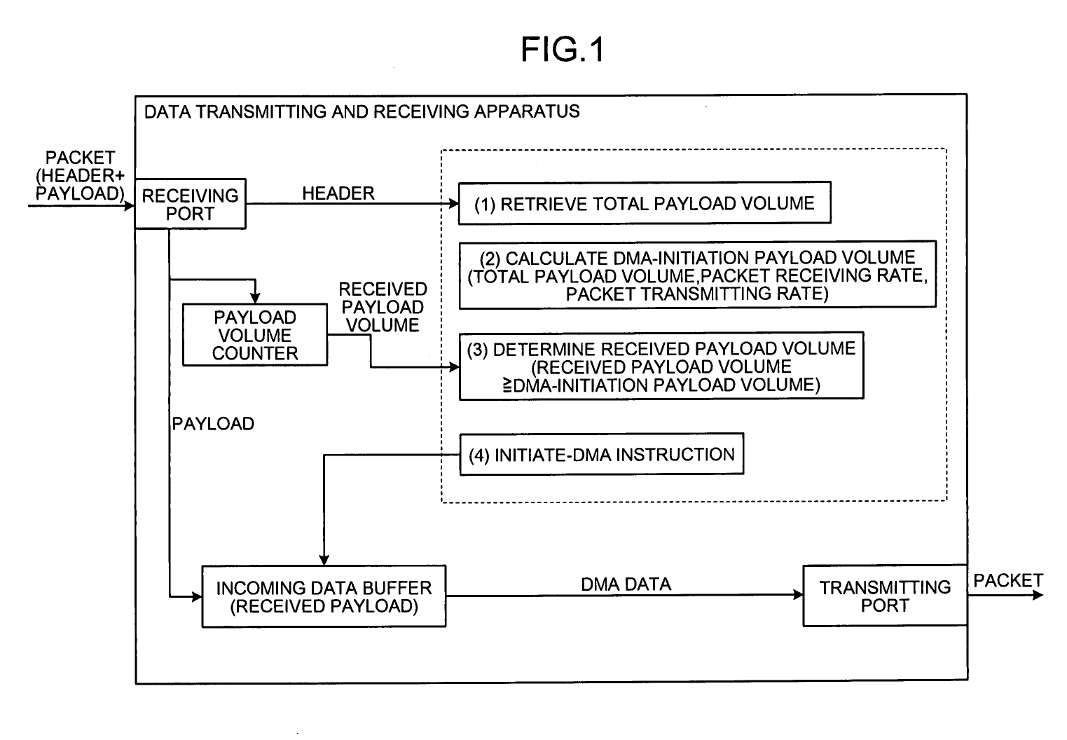

FIG. 1 is a schematic for explaining an overview of a data transmitting and receiving apparatus according to an embodiment of the present invention. The data transmitting and receiving apparatus employs the cut-through method in which incoming packets are accumulated in an incoming data buffer and the accumulated packets are forwarded even before all the packets for certain data are received. Although the data transmitting and receiving apparatus is based on cut-through method, it is so configured that no buffer underruns occur.

Precisely, the data transmitting and receiving apparatus measures a received payload volume RPS, from a payload included in a packet being currently received from one device (not shown), with a payload volume counter, sequentially accumulates payloads included in the received packets in an incoming data buffer, and obtains information about a total payload volume TP from a header included in the packet that is being currently received (see (1) of FIG. 1).

Next, the data transmitting and receiving apparatus calculates a DMA-initiation payload volume DSPS based on the total payload volume TP, a transmitting rate RR of a receiving port, and a transmitting rate TR of a transmitting port of the data transmitting and receiving apparatus (see (2) of FIG. 1). The data transmitting and receiving apparatus calculates the DMA-initiation payload volume DSPS, for example, based on DSPS=TP×(1−RR/TR).

Subsequently, the data transmitting and receiving apparatus determines whether the received payload volume RPS has reached the calculated DMA-initiation payload volume DSPS (see (3) of FIG. 1). If it is determined that RPS has reached DSPS, the data transmitting and receiving apparatus outputs an initiate-DMA instruction to the incoming data buffer. Upon receiving the initiate-DMA instruction, the incoming data buffer outputs the accumulated payload as DMA data to the transmitting port. The output DMA data is transmitted via the transmitting port to another device (which can be a main memory in a server) as packets (see (4) of FIG. 1).

Thus, the data transmitting and receiving apparatus according to the embodiment is capable of preventing occurrence of buffer underruns.

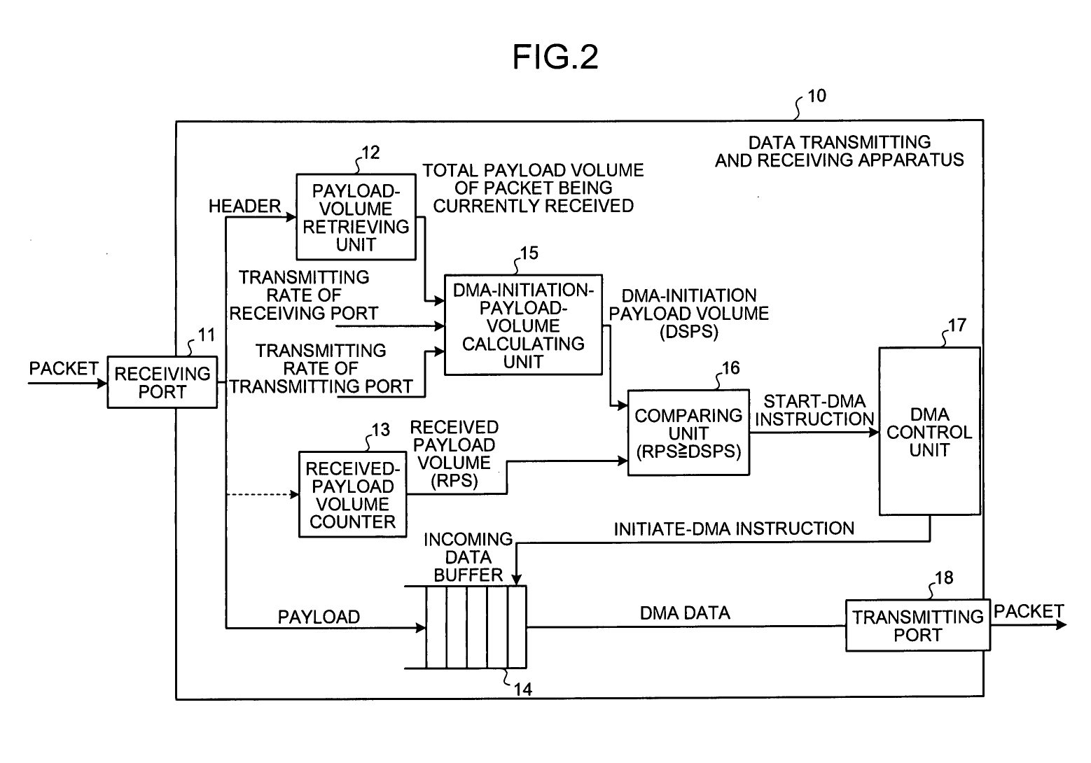

FIG. 2 is a functional block diagram of a data transmitting and receiving apparatus 10 according to a first concrete example of the embodiment. The data transmitting and receiving apparatus 10 includes a receiving port 11, a payload-volume retrieving unit 12, a received-payload volume counter 13, an incoming data buffer 14, a DMA-initiation-payload-volume calculating unit 15, a comparing unit 16, a DMA control unit 17, and a transmitting port 18.

The receiving port 11 receives the packets transmitted by, for example, another network device (not shown). The header of the packet received by the receiving port 11 is output to the payload-volume retrieving unit 12, and the payload of the packet is output to the incoming data buffer 14.

The payload-volume retrieving unit 12 refers to the header and retrieves information about the total payload volume TP included in the packet to which the header belonged. The payload-volume retrieving unit 12 outputs the retrieved total payload volume TP to the DMA-initiation-payload-volume calculating unit 15.

The received-payload volume counter 13 measures the volume of the payload of the packet to which the payload belonged. Specifically, the received-payload volume counter 13 measures received payload volume RPS of the payload, i.e., payload accumulated in the incoming data buffer 14, and outputs the calculated received payload volume RPS to the comparing unit 16.

The incoming data buffer 14 accumulates the payloads, and upon receiving an initiate-DMA instruction from the DMA control unit 17, starts outputting the accumulated payload as DMA data to the transmitting port 18.

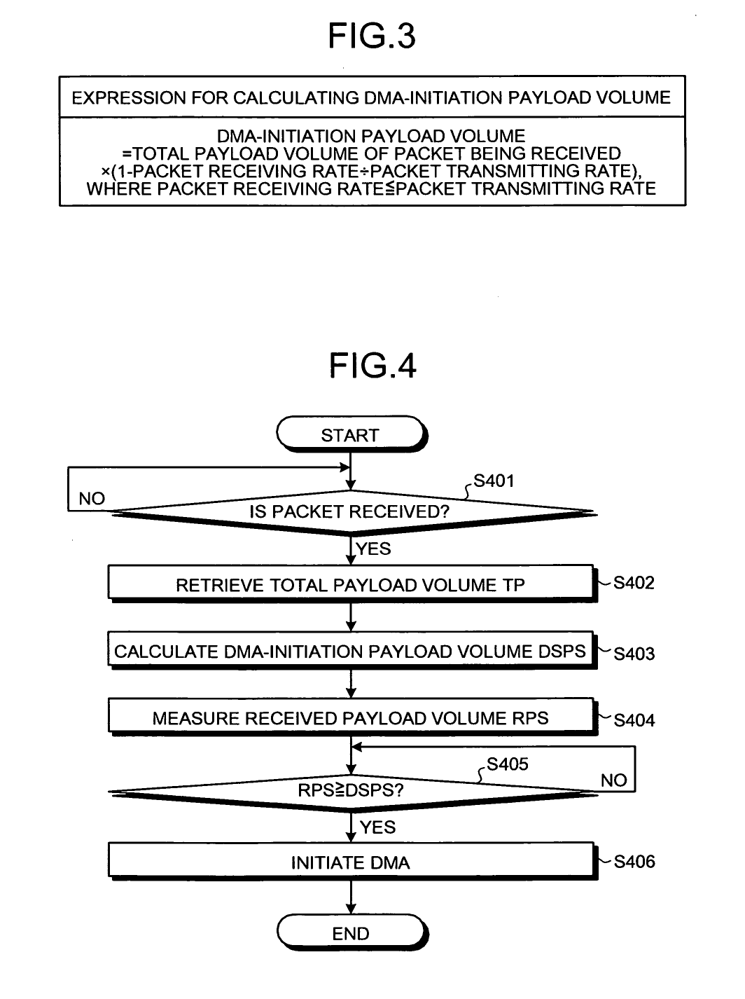

The DMA-initiation-payload-volume calculating unit 15 calculates the payload volume required for initiating DMA. Specifically, if the total payload volume is TP, a transmitting rate of the receiving port 11 is RR, a transmitting rate of the transmitting port 18 is TR, then the DMA-initiation-payload-volume calculating unit 15 calculates a DMA-initiation payload volume DSPS as DSPS=TP×(1−RR/TR) (see FIG. 3). The DMA-initiation-payload-volume calculating unit 15 outputs the calculated DMA-initiation payload volume to the comparing unit 16. The transmitting rate RR of the receiving port 11 and transmitting rate of the transmitting port TR are set when the data transmitting and receiving apparatus 10 is started up or reset, and once set they do not change.

The comparing unit 16 performs a determination process on the received payload volume RPS. Specifically, the comparing unit 16 determines whether the received payload volume RPS has reached the DMA-initiation payload volume DSPS. If it is determined that RPS≧DSPS, the comparing unit 16 outputs a start-DMA instruction to the DMA control unit 17. If it is determined that RPS≧DSPS is not true, the comparing unit 16 repeatedly performs the determination process until RPS≧DSPS.

The DMA control unit 17 controls DMA initiation. Specifically, upon receiving the start-DMA instruction, the DMA control unit 17 outputs an initiate-DMA instruction to the incoming data buffer 14. The transmitting port 18 transmits packets to another network device (not shown). Specifically, upon receiving the initiate-DMA instruction from the DMA control unit 17, the transmitting port 18 transmits the DMA data as packets to another network device.

FIG. 4 is a flowchart of a process procedure performed by the data transmitting and receiving apparatus 10. When a packet is received at the receiving port 11 (“Yes” at step S401), the payload-volume retrieving unit 12 refers to a header of the packet and retrieves information about a total payload volume TP included in the packet (step S402). Next, the DMA-initiation-payload-volume calculating unit 15 calculates a DMA-initiation payload volume DSPS (step S403). Specifically, the DMA-initiation-payload-volume calculating unit 15 calculates the DMA-initiation payload volume DSPS as DSPS=TP×(1−RR/TR), where RR is a transmitting rate of the receiving port 11 and TR is a transmitting rate of the transmitting port 18.

Next, the received-payload volume counter 13 measures received payload volume RPS of the payload, i.e., payload accumulated in the incoming data buffer 14 (step S404). Subsequently, the comparing unit 16 determines whether RPS≧DSPS (step S405). If it is determined that RPS≧DSPS (“Yes” at step S405), the comparing unit 16 outputs a start-DMA instruction to the DMA control unit 17, and upon receiving the start-DMA instruction, the DMA control unit 17 outputs an initiate-DMA instruction to the incoming data buffer 14 to initiate the DMA (step S406). If it is determined that RPS≧DSPS is not true (“No” at step S405), the comparing unit 16 repeats the determination process on the received payload volume reaches the DMA-initiation payload volume.

According to the first concrete example, in the data transmitting and receiving apparatus, it is possible to prevent occurrence of buffer underruns.

All the automatic processes explained in the embodiment can be, entirely or in part, carried out manually. Similarly, all the manual processes explained in the present embodiment can be entirely or in part carried out automatically by a known method. The process procedures, the control procedures, specific names, and data, including various parameters, can be changed as required unless otherwise specified.

The constituent elements of the data transmitting and receiving apparatus 10 are merely conceptual and may not necessarily physically resemble the structures shown in the drawings. For example, the data transmitting and receiving apparatus 10 need not necessarily have the structure that is illustrated. That is, some or all of the elements can be broken down or integrated either functionally or physically in accordance with the load or how the apparatus is to be used. Further, the process functions can either entirely or in part be performed by a computer program executable by a central processing unit (CPU) (not shown) or by a hardware (not shown) using wired logic.

The process procedure performed by the data transmitting and receiving apparatus 10 can be realized on a computer by executing a computer program on the computer. The computer can be a personal computer or a workstation. For example, the computer program can be loaded onto a designated register (for example, a register responsible for DMA initiation) in the data transmitting and receiving apparatus 10 and executed to realize the process procedure. The computer program can be distributed over a network such as the Internet. The computer program can be recorded on a computer-readable recording medium such as a hard disk, flexible disk (FD), compact disk-Read-Only memory (CD-ROM), magneto optic (MO) disk, digital versatile disk (DVD), etc. and can be executed by the computer by loading the program from the recording medium.

According to an aspect of the present invention it becomes possible to prevent occurrence of underruns in a network device that employs the cut-through method.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A data transmitting and receiving apparatus that accumulates packets received from a first device and transmits accumulated packets to a second device without waiting for receiving all packets belonging to certain data from the first device, the data transmitting and receiving apparatus comprising:
a storage unit that accumulates therein payloads of packets received from the first device;
a payload-volume calculating unit that calculates a designated payload volume DSPS based on DSPS=TP×(1−RR/TR) where TP is a total payload volume of a packet received at a certain time point from the first device, RR is receiving rate of packets, and TR is transmitting rate of packets;
a payload-volume determining unit that determines whether payload volume RPS accumulated in the storage unit has reached the designated payload volume DSPS; and
a payload transmission control unit that, if the payload volume determining unit determines that the payload volume RPS has reached the designated payload volume DSPS, provides a control to start transmission of the payload accumulated in the storage unit to the second device.

2. The data transmitting and receiving apparatus according to claim 1, further comprising a receiving port that receives packets from the first device.

3. The data transmitting and receiving apparatus according to claim 2, wherein the receiving rate RR of packets is a transmitting rate of the receiving port.

4. The data transmitting and receiving apparatus according to claim 1, further comprising a transmitting port that transmits payload accumulated in the storage unit to the second device as packets.

5. The data transmitting and receiving apparatus according to claim 4, wherein the transmitting rate TR of packets is a transmitting rate of the transmitting port.

6. The data transmitting and receiving apparatus according to claim 1, wherein the storage unit is based on direct memory access.

7. The data transmitting and receiving apparatus according to claim 1, further comprising a payload-volume retrieving unit that retrieves the total payload volume TP of a packet from a header of the packet.

8. A data transmitting and receiving method of accumulating packets received from a first device and transmitting accumulated packets to a second device without waiting for receiving all packets belonging to certain data from the first device, the data transmitting and receiving method comprising:
accumulating payloads of packets received from the first device in a storage unit;
calculating a designated payload volume DSPS based on DSPS=TP×(1−RR/TR) where TP is a total payload volume of a packet received at a certain time point from the first device, RR is receiving rate of packets, and TR is transmitting rate of packets;
determining whether payload volume RPS accumulated in the storage unit has reached the designated payload volume DSPS; and
starting transmission of the payload accumulated in the storage unit to the second device when it is determined at the determining that the payload volume RPS has reached the designated payload volume DSPS.

9. The data transmitting and receiving method according to claim 8, wherein the storage unit is based on direct memory access.

10. The data transmitting and receiving method according to claim 8, further comprising retrieving the total payload volume TP of a packet from a header of the packet.

11. A computer-readable recording medium that stores therein a computer program that implements on a computer a method of accumulating packets received from a first device and transmitting accumulated packets to a second device without waiting for receiving all packets belonging to certain data from the first device, the computer program causing the computer to execute:
accumulating payloads of packets received from the first device in a storage unit;
calculating a designated payload volume DSPS based on DSPS=TP×(1−RR/TR) where TP is a total payload volume of a packet received at a certain time point from the first device, RR is receiving rate of packets, and TR is transmitting rate of packets;
determining whether payload volume RPS accumulated in the storage unit has reached the designated payload volume DSPS; and
starting transmission of the payload accumulated in the storage unit to the second device when it is determined at the determining that the payload volume RPS has reached the designated payload volume DSPS.

12. The computer-readable recording medium according to claim 11, wherein the storage unit is based on direct memory access.

13. The computer-readable recording medium according to claim 11, the computer program further causing the computer to execute retrieving the total payload volume TP of a packet from a header of the packet.
